(19) United States
(12) Patent Application Publication
(10) Pub. No.: US 2026/0314812 A1
(43) Pub. Date: Oct. 15, 2026

(54) Combination Toothbrush Wipe and Wrap; System and Method of Use

(71) Applicant: Nookology LLC, Hoboken, NJ (US)

(72) Inventors: Brian J. Gellman, Hoboken, NJ (US); Marc Gellman, Miami Beach, FL (US)

(73) Assignee: Nookology LLC, Hoboken, NJ (US)

(21) Appl. No.: 19/648,889

(22) Filed: Apr. 15, 2026

Related U.S. Application Data
(60) Provisional application No. 63/789,346, filed on Apr. 15, 2025.

(51) Int. Cl. A46B 17/04; B65D 5/38; B65D 75/14; B65D 83/08; F26B 5/14

(52) U.S. Cl. CPC A46B 17/04; B65D 5/38; B65D 75/14; B65D 83/0882; F26B 5/14; A46B 2200/1066

(57) ABSTRACT

The combination toothbrush wipe and wrap is packaged together in a dispenser creating a unique product, system, and method for protecting a brush.

Aspects of the system accommodate one-time use—for example, a single, sealed packet provides one wipe and one wrap for maximum portability. Other aspects of the system call for containers with ala carte dispensing of a wipe versus a wrap and permits a user to customize their use of the combination of the wipe and the wrap. The use of the wipe to dry the brush and remove debris will improve the cleanliness and hygienic experience of oral and dental care. Then, the wrap to cover the bristles permits more hygienic storage of toothbrushes in between uses or even when traveling due to the customization of the fit around the bristles and perforations in the wrap which encourage airflow to dry the bristles.

### CROSS-REFERENCE TO RELATED APPLICATIONS

This patent application claims priority under 35 U.S.C. § 119(e) to U.S. Patent Application Ser. No. 63/789,346, entitled “Combination Toothbrush Wipe and Wrap; System and Method of Use”, and filed on Apr. 15, 2025. This application is now pending. The entire disclosure of the patent application is hereby incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

### 1. Field of the Invention

This invention relates to toothbrush storage, and more particularly to such a system for drying and covering a toothbrush head in between uses, and providing a packaged combination of a wipe and wrap.

### 2. Description of the Related Art

Harmful microorganisms can grow on common items such as toothbrushes, particularly when they are kept in bathroom environments. In fact, the bathroom in general can be one of the most infectious environments in the household. Toothbrushes are regularly carried with individuals as they travel or visit places like hospitals, restaurants, hotels, and guest residences. They are regularly transported in luggage, pockets, bags, and purses.

Microorganisms thrive in moist, cool dark places and those characteristics are consistent with the places that people store or transport items such as toothbrushes. For example, bathrooms typically have high humidity levels and are subject to many airborne microorganisms, including those that may be dispersed with each flush of a toilet. Pathogens introduced into the oral cavity during brushing possess the potential to impact systemic health. Toothbrushes, once contaminated, cannot be easily cleaned and must be discarded.

While disposable wipes designed for oral hygiene have been introduced in the market, they are specifically directed and formulated for cleaning teeth, gums, or oral retainers. These wipes are not suited to drying toothbrush bristles and cannot wrap the toothbrush head after use.

Numerous methods have been developed to protect toothbrushes during travel and storage. Conventional accessories—such as travel cases and bristle covers—are widely utilized to maintain hygiene and convenience in both daily life and travel scenarios. Many existing storage containers are designed to accommodate diverse bristle shapes and sizes. However, these efforts have not fully addressed the challenge of properly wiping and safeguarding toothbrushes from contaminants.

### BRIEF SUMMARY OF THE INVENTION

The present invention provides a combination toothbrush wipe and wrap with particular advantages over the prior art. The toothbrush wipe of the combination is an absorbent sheet and the wrap of the combination is a unique, non-absorbent material that is pliable, compressible, conformable, and self-grabbing. The compressible, self-grabbing thin material adheres back to itself anywhere along the sheet and has important shapable properties to customize the fit of the wrap to any toothbrush head without falling off. The preferred wrap material has breathable properties, for instance, in one example material, perforations permit airflow to the bristles. In one embodiment, the combination absorbent sheet and the pliable sheet are contained within a single packet, also called a package, which may be hermetically sealed and may include a corner peal or tear notch or tear strip. In commercial embodiments of the invention, a number of packets holding wrapped pairings will be grouped and sold in a boxed set or in a single carton of various quantities. The box set or carton could be purchased directly by the end user or retail stores could offer the packets labeled for individual sale from a carton near the checkout area. The packets offered for single package purchase by the end users are similar to other grab and go products sold in convenience stores or travel kiosks.

In some embodiments, the combination toothbrush wipe and pliable toothbrush wrap, comprises a plurality of disposable absorbent sheets, and a plurality of wrap sheets wherein each of the plurality of absorbent sheets and each of the plurality of pliable sheets are individually dispensed from a single container. In these variations, the plurality of disposable absorbent sheets are stacked, folded, or rolled, and stored in a first section of the single container and each of the plurality of disposable absorbent sheets are stacked, folded, or rolled, and stored in a second section of the single container. The single container is desirably a double compartment container. In one example, the container has two dispensers and those may be made with dual, slide-out sleeves, with sliding sheaths, with dual, foldable pockets, or with two rollers. The dispensers may slide horizontally or vertically in two directions or in one direction or they may be stacked or back-to-back. The plurality of pliable sheets that are stacked, rolled, or folded may be separated by contact or buffer sheets to aid in their storage. For rolled or contiguously joined or tethered absorbent sheets, each may be separated by a line of perforations that allow for easy separation by pulling, tearing, or cutting.

In yet another variation, the combination wipe and wrap is provided with a dedicated dispenser wherein the dispenser holds the plurality of absorbent sheets and the plurality of pliable sheets. In some cases, the dispenser may permit the sheets to be joined contiguously, separated by a line of perforations, and spooled around a set of rolls which are housed within a single container. In this example, the first roll holds the plurality of disposable absorbent sheets and the second roll holds the plurality of pliable sheets. In other dispensers, the plurality of absorbent sheets are folded such that the removal of one absorbent sheet from the dispenser exposes an end of a next absorbent sheet. Likewise, the plurality of pliable sheets are folded such that removal of one pliable sheet from the dispenser advances and exposes an end of a next pliable sheet for further dispensing. For single-port dispensers, the wrap and wipe may alternate within the single dispenser.

One example of a method of using the combination contemplated in the present disclosure comprises the steps of:
using the toothbrush in a conventional manner causing a bristle head to become wet,
retrieving an absorbent wipe,
drying the bristle head with the absorbent wipe,
discarding the absorbent wipe,
retrieving a pliable sheet,
wrapping the bristle head in the pliable sheet such that the deformable sheet molds around the bristle head and adheres to itself and the brush handle,
whereby the bristle head is reliably protected for transport or storage until the next use.

Consistent with this disclosure, the method of using the combination may include retrieval of the absorbent wipe and the pliable sheet from separate containers or a single container.

The system of the present invention permits the hygienic drying and storing of a toothbrush, and comprises: a single box and a plurality of sealed packets contained in the single box; each of the plurality of sealed packets further comprising a disposable absorbent sheet and a pliable sheet having contiguous self-adhesive and breathable properties; wherein each of the plurality of sealed packets is dispensed from the single box and unsealed to first access the disposable absorbent sheet useful in removing moisture from a toothbrush bristle head, whereupon the pliable sheet is also accessed and wrapped to mold around the toothbrush to substantially cover the toothbrush bristle head until the toothbrush is again deployed for use.

By placing the dried toothbrush in the wrap before or between uses, the brush is protected from contamination by microbes, thereby making the system suitable for use in many scenarios, including wherever sanitary conditions are not known to exist.

The wrap is preferably constructed of materials that are permeable to vapors so that the enclosed item, particularly the toothbrush, may dry. The wipe and wrap materials are preferably disposable to help meet the sanitary objectives of the invention.

The present invention offers a wrap which is a customizable cover suitable to fit any toothbrush head so that it will not fall off.

More specifically, and in a presently preferred embodiment, by way of example and not necessarily by way of limitation, a beeswax paper material meets the objectives for the wrap material.

It is an objective of the present invention to dry toothbrush bristles after use.

It is another objective of the present invention to wrap toothbrush bristles between uses.

It is also an objective of the present invention to store a toothbrush in a hygienic manner.

It is another objective of the present invention to provide for a disposable system.

It is an objective of the present invention to provide a compressible, conformable, self-grabbing thin material that clings or adheres back to itself and that the material is deformable, pliable, shapeable, malleable, or moldable wrap.

It is yet another objective of the present invention that the wrap can be bent, influenced, pinched, folded, twisted, and manipulated to create a custom-sized wrap.

It is also an objective of the present invention that the wrap material will cling back upon itself multiple times.

It is another objective of the present invention to provide for some, optionally reusable materials to reduce waste.

It is an objective of the present invention to provide individual packets so that the combination of one wipe and one wrap are provided together.

It is a further objective of the present invention to provide cartons of packets for grab and go use or purchasing.

It is also an objective of the present invention to provide two separate materials in one container.

It is another objective of the present invention to provide a container that optimizes the manner in which the respective materials are dispensed.

The present invention features moisture removal and offers customizable and reliable fit or self-grabbing properties.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration, the advantages and objects of the present invention. Each drawing is referenced by corresponding figure reference characters within the “DETAILED DESCRIPTION OF THE INVENTION” section to follow.

FIG. 1 is a perspective view of one example of the combined wipe and wrap system for a toothbrush.

FIG. 2 is a perspective view of the dry wipe shown in isolation.

FIG. 3 is a perspective view of the dry wipe illustrating the wipe being placed around the head of a toothbrush to begin the drying process.

FIG. 4 is a perspective view of the dry wipe around the bristles of a toothbrush, representing the implementation of the drying process and the wipe being used to absorb any liquid within the bristles of the toothbrush.

FIG. 5 is a perspective view of the wrap shown in isolation.

FIG. 6 is a perspective view of a toothbrush head being placed near the center of the wrap.

FIG. 7 is a perspective view of the wrap from FIG. 6 being folded in one manner around the toothbrush head.

FIG. 8 is a perspective view of the wrap from FIG. 7 completely surrounding the toothbrush head, representing the top folded over and the base pressed around the toothbrush handle.

FIG. 9 is a perspective view of the toothbrush head after the wrap has been fully applied to the toothbrush head according to one representation of conforming the wrap.

FIG. 10 is a perspective view of a sealed packet being opened from a corner peel and a paired dry wipe and wrap being removed from the packet.

FIG. 11 is a perspective view of the paired dry wipe and wrap from FIG. 10 after removal from the packet.

FIG. 12 is a perspective view of the fully assembled sealed packet with an alternative tear notch for opening by the user, the packet having just been removed from the carton holding many packets and the carton tray partially enclosed by a protective sheath.

FIG. 13 is a disassembled perspective view of FIG. 12 showing each component of the combined system in isolation including the multi-packet carton, one packet removed, and the unsealed single dry wipe and single wrap.

FIG. 14 is a perspective view of a fully assembled combination dry wipe and wrap system of FIG. 13.

FIG. 15 is an end view of FIG. 14 demonstrating the carton tray held within the carton sheath.

FIG. 16 is a front perspective view of a box used to hold multiple sealed packets.

FIG. 17 is a front perspective view of a box used to hold multiple sealed packets and the box having a hanging tab for retail displays.

FIG. 18 is a perspective view of another container used to hold multiple sealed packets.

FIG. 19 is a perspective view of the container from FIG. 18 in the open position and demonstrating how the sealed packets are held within and removed from the container.

FIG. 20 is a perspective view of an alternative sealed packet having a tear strip for opening.

FIG. 21 is a perspective view demonstrating the folded assembly of the dry wipe and wrap within the packet of FIG. 20 after tearing the opening strip to open the packet.

FIG. 22 is a perspective view of the folded dry wipe and folded wrap removed from the packet of FIG. 21.

FIG. 23 is a perspective view of the dry wipe from FIG. 22 demonstrating use to remove moisture and debris from the head of a toothbrush.

FIG. 24 is a perspective view of the dry toothbrush from FIG. 23 being placed within the wrap.

FIG. 25 is a perspective view of a toothbrush head completely protected by the wrap.

FIG. 26 is a perspective view of an alternative sealed packet utilizing a central divider seal separating the dry wipe and wrap into individual packet sections, also called chambers. In this version, a perforated line is added as an aid to tear apart the combination into two halves while the wipe and wrap remain in their respective chambers.

FIG. 27 is another divided packet with a wipe in the first section openable by a corner peel, a wrap in a second section also openable by a corner peel, and the sections divided by a heat seal.

FIG. 28 is a front and back view of another divided packet that utilizes a tear notch for opening each section.

FIG. 29 is another view of a divided packet with a tear notch for opening and perforated tear line along the center seal.

FIG. 30 is a perspective view showing the contents of FIG. 29 after opening to demonstrate the folded configuration of the wipe and the wrap.

FIG. 31 is a perspective view of the wipe and the wrap fully removed from the packet in FIG. 30 to fully demonstrate the folded configurations of the respective wipe and wrap and also demonstrate a desirable dog-ear used for unfolding the wrap.

FIG. 32 is a side perspective view of a foldable dual compartment container used for dispensing a drying wipe and wrap system shown in the open position.

FIG. 33 is a front perspective view of FIG. 32.

FIG. 34 is a partially closed view of FIG. 33.

FIG. 35 is a front perspective view of FIG. 33 but in a fully closed position.

FIG. 36 is a side perspective view of FIG. 35.

FIG. 37 is a front perspective view of a dual compartment slide out container used for dispensing a drying wipe and wrap system shown in the closed position.

FIG. 38 is a front perspective view of the dual slide out container of FIG. 37 with the first compartment in the open position for dispensing a dry wipe and the second compartment in the open position for dispensing a wrap.

FIG. 39 is a top view of the dual compartment slide out container of FIGS. 37-38 used for dispensing a drying wipe and wrap system shown in the closed position with the two compartments slid in to each side of the container (as represented by broken lines).

FIG. 40 is a side view of FIG. 39.

FIG. 41 is a perspective view of the dual compartment slide out container with the two compartments each sliding toward the open position. No wipes or wraps are visible.

FIG. 42 is a perspective view of a double compartment dispenser using the double roll configuration and having a wipe being pulled from a first roll and a wrap being pulled from a second roll.

FIG. 43 is a cross-section taken from the arrows A-A in FIG. 42.

### DETAILED DESCRIPTION OF THE INVENTION

In the following description, reference is made to the accompanying drawings that form a part hereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

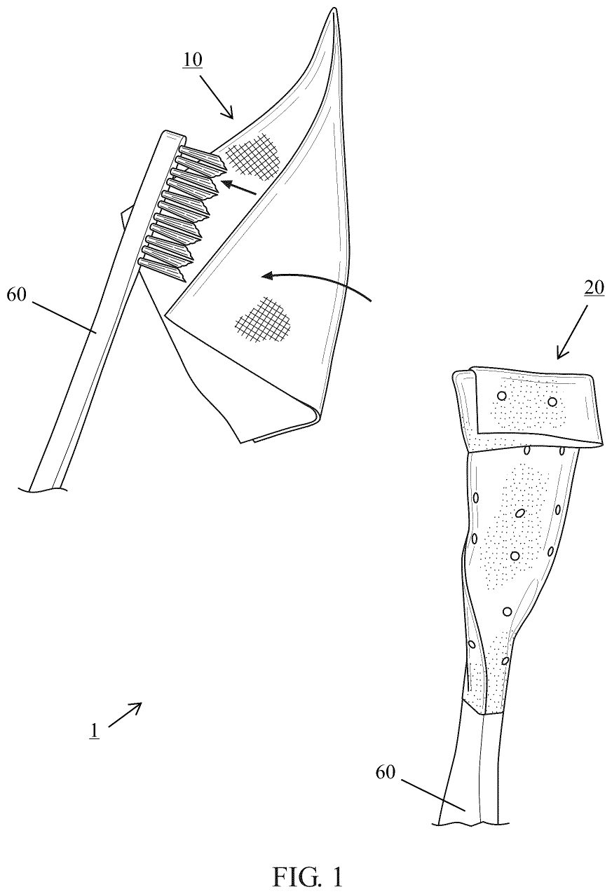

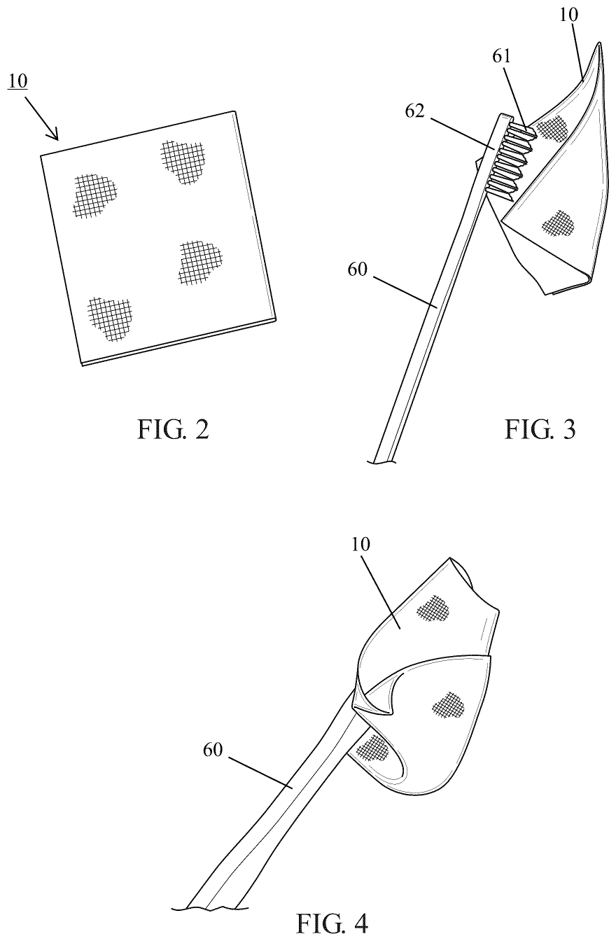

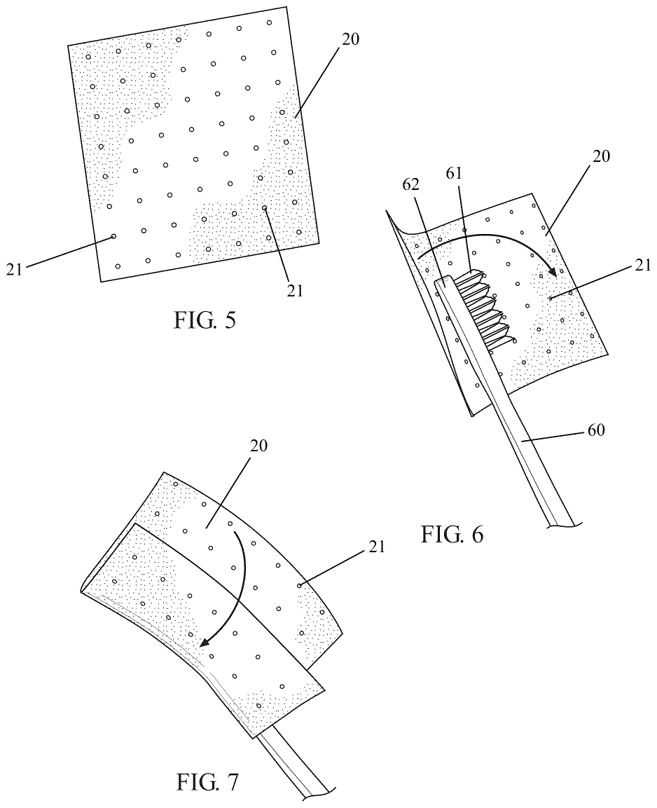

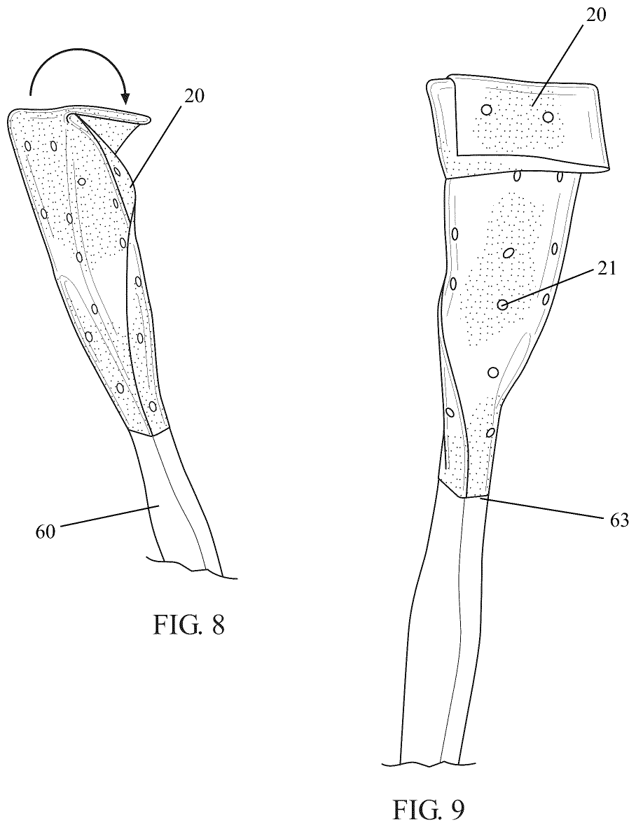

FIG. 1 depicts one embodiment of a wipe and wrap system 1. FIGS. 2-9 demonstrate each of the steps for use of the system 1. After a user brushes his/her teeth (not shown), the toothbrush 60 is wiped with the disposable absorbent sheet material 10 (see FIGS. 2-4) to remove debris and some moisture, leaving cleaner bristles 61 on the head 62. Once the user is satisfied that the wiping is complete, then the toothbrush bristle head 62 is enclosed within the protective wrap 20 (see FIGS. 5-9). One example of the procedure to use will be through the steps of placing the brush head 62 near the center of the protective wrap 20 (see FIG. 6) and bending the wrap 20 around the back of the brush and the bristles until two of the edges of the wrap overlap and the bristle head 62 is encircled by the wrap 20 (see FIG. 7). Then, as suggested by the arrow in FIG. 8, the top of the wrap 20 is folded down over the top of the brush to enclose the bristle head 62.

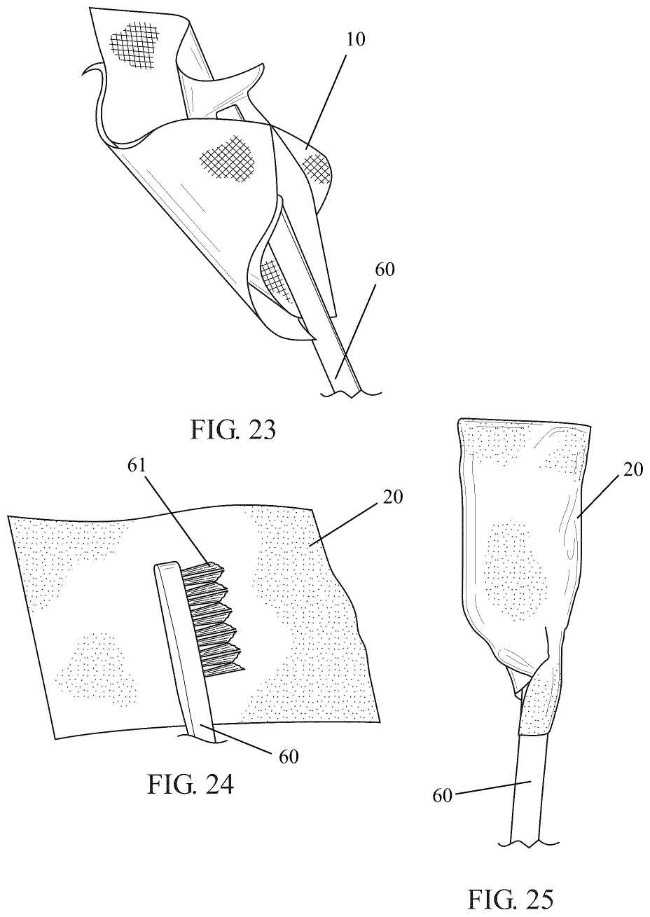

Finally, the bottom of the wrap 20 is twisted to grab securely around the brush handle 63 near the bottom of the bristle head 62. The final enclosure of the brush head 62 within the wrap 20 according to this embodiment is shown in FIG. 9. In another version of the wipe and wrap combination, the wrapping material does not include visible perforations. This variation is illustrated in FIGS. 23-25, where it is apparent, the wiping and wrapping steps are repeated, but with slightly varied wrapping material. FIG. 25 also helpfully illustrates one example of another wrapping style that is easily employed with the self-adhering and malleable characteristics of the wrapping material. Various wrapping configurations which protectively cover the toothbrush head will meet the objectives of the present invention.

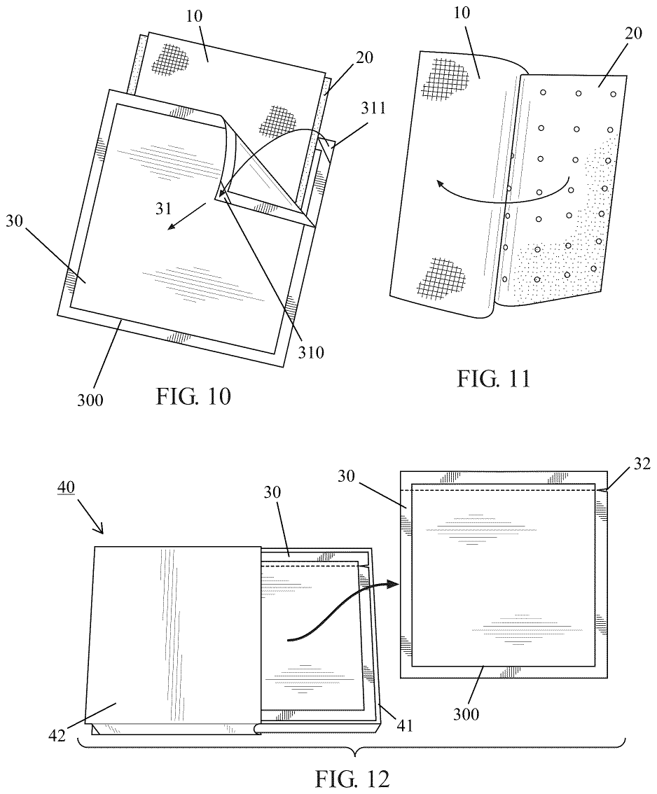

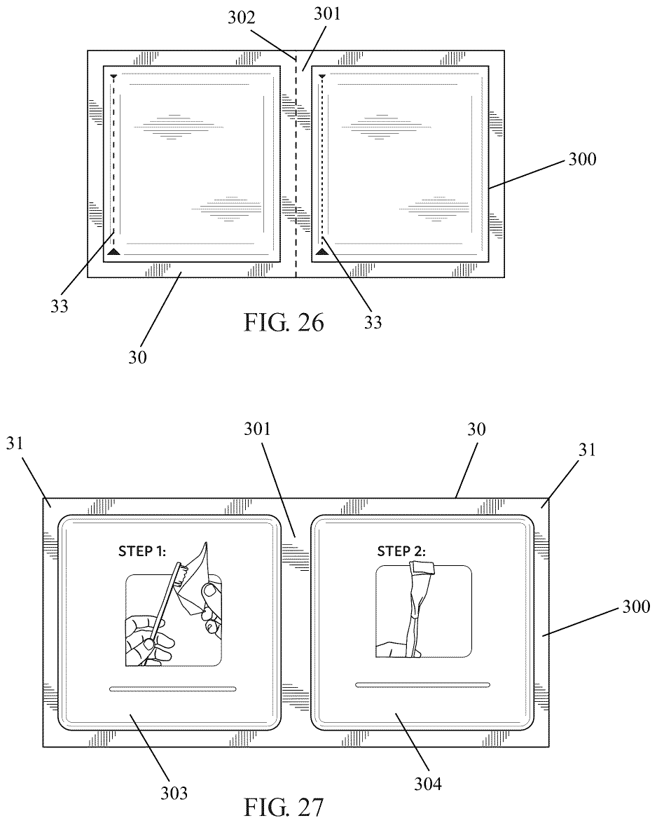

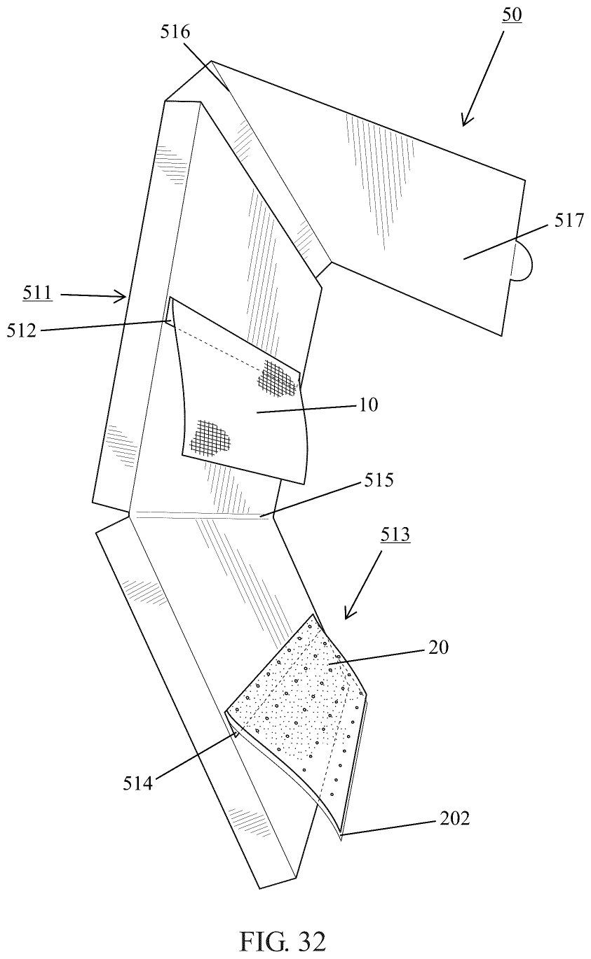

FIGS. 10-22 demonstrate the preferred one for one combination pairing of a wipe and a wrap in a joined and shared enclosure with a seal breaching access. The configuration of the combination of wipe and wrap within the enclosure can vary from layering, to folding, to nesting, for example. Later examples illustrate separation of the wipe and wrap (see FIGS. 26-31. Still later examples, such as those in FIGS. 32-43, contemplate storage of multiple iterations of the wipe material apart from multiple iterations of the wrap material. This modularity between grouping styles will be desirable for particular consumer product interfaces. Whether portable pairings are provided or bulk materials in economic volume are offered, the combination wipe and wrap will perform the necessary function of drying and covering a toothbrush as illustrated in FIGS. 1-9 or FIGS. 23-25.

In the accompanying figures, various packaging options are illustrated. The package demonstrated in FIGS. 10-11 is the first example of a packaging style which may be desirable for the system. In this example, one wipe is paired with one wrap as shown in FIG. 10. The pairing is enclosed within a dedicated sealed packet 30. In this example, an unsealed corner peel 31 is provided as the package seal-breaching feature for easy opening such that each panel of the packet 30 has a first ear 310 for grabbing to pull away from the second ear 311. When the two corner peels 31 are pulled apart, the sealed packet 30 is opened and exposes the paired combination of the wipe 10 and wrap 20. FIG. 10 also demonstrates the combination wipe 10 and a wrap 20 nested together in a layered manner. Turning to FIG. 11, the wipe 10 and wrap 20 are removed from the packet and are illustrated as being separated and made ready for use.

Another variation of a sealed packet 30 is illustrated in FIGS. 12-13, 16 and 19. In these packaging illustrations, the demonstrated packet 30 is the variation provided with a tear notch 32 where the user can grab and pull in opposing directions of the tear notch 32 to breach the seal 300 and initiate ripping the packet 30 open.

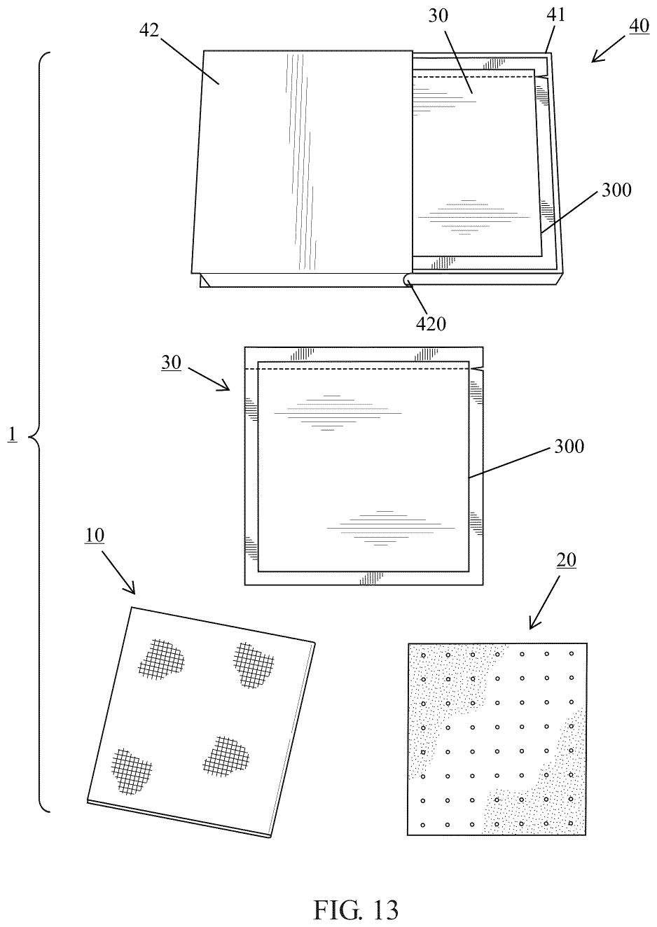

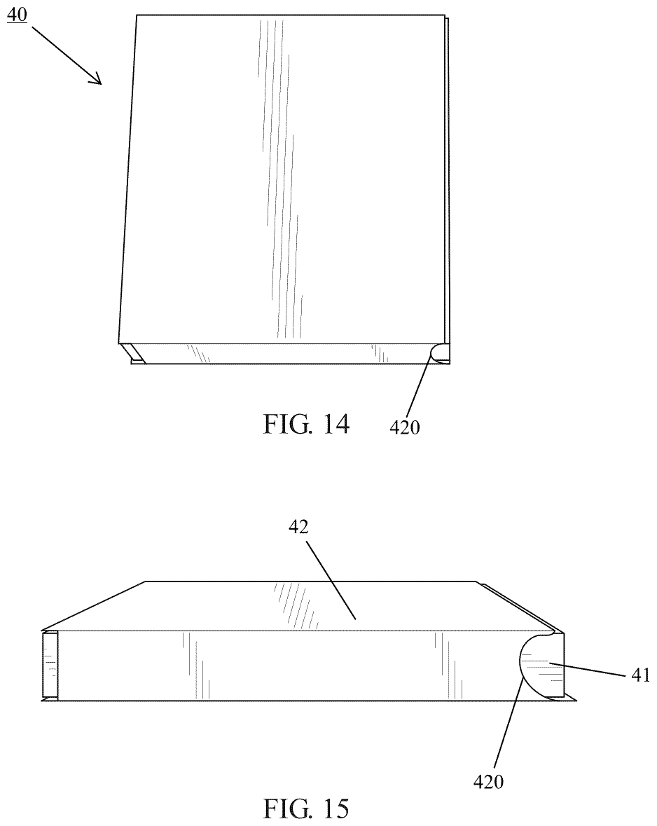

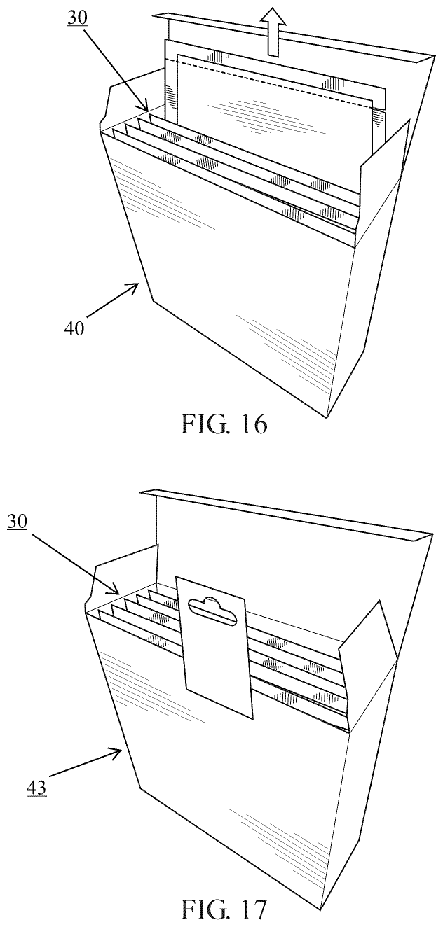

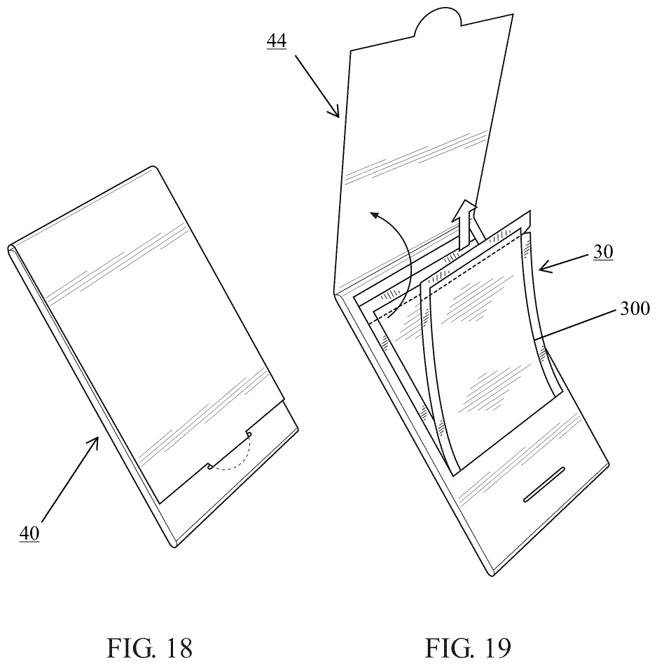

Now, three alternative groupings of the sealed packets are depicted in FIGS. 12-19, including a slide out tray 40, a hanging box 43, and a fold out, envelope style carton 44. Any grouping of sealed packets 30 may be presented in a multi-packet container 40 such as the options shown in FIGS. 12-15, FIG. 16-17, or FIGS. 18-19. First, with reference to the example in FIGS. 12-15, the multi-packet container 40 is illustrated as a five-sided slidable tray 41 configured to mate with a complementary sheath 42. For a sheath 42 that can slide one direction, five sheath sides are provided (see FIGS. 12-13). For a sheath 42 in which the tray 41 can slide in and out from either side, four sheath side walls are provided (see FIGS. 14-15). In this version, a user would grab the respective compartments at the sheath cutouts 420 (see FIGS. 13-15) and slide the tray out of the respective ends of the sheath. FIG. 13 shows each of the pieces of the system 1 employing the multi-packet container 40 arrangement including a wipe 10, a wrap 20, a sealed packet 30, a tray 41, and a sheath 42. As an alternative to the tray and sheath multi-packet container 40, a box 43 design such as that shown in FIGS. 16-17 will allow for larger groupings of the sealed packets.

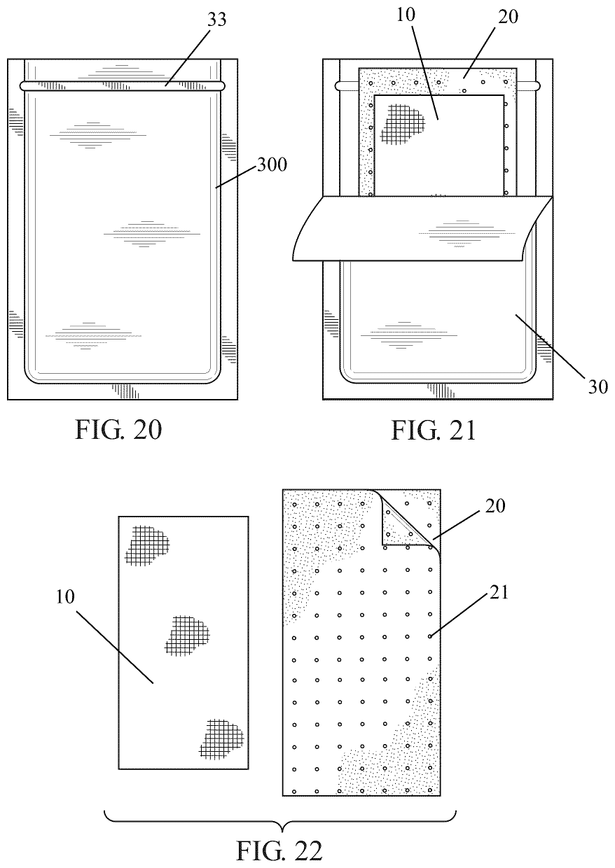

Referring now to FIGS. 18-19, the features of the invention in another storage arrangement are illustrated. FIG. 18-19 illustrate the envelope-style container 44, which is another container 40 that can hold multiple, sealed packets 30, or even be labeled for individual sale so that just one is offered for single use purposes, convenience store purchases, or samples. A single wipe and wrap system contained within individual sealed packets may be desirable particularly for travel use. The user may select a particular quantity of packets to carry within their toiletry bag and the contents of each packet will remain sanitary until opened by the user. Once again, each wipe is accompanied by one wrap as shown in FIGS. 21-22. The combination is enclosed within another sealed packet 30 as represented in FIGS. 20-21. This sealed packet will also have an access aid to breach the seal 300, such as the tear strip 33 represented in FIG. 20 in an unopened view or in FIG. 21 in an opened view. For use, the packet 30 is removed from any container 40, the seal is broken (see FIG. 21), a wipe 10 and wrap 20 are removed from the sealed packet 30 (see FIG. 22), the toothbrush is wiped (see FIG. 23) and after discarding the wipe then the toothbrush head is wrapped (see FIGS. 24-25). FIGS. 20-25 illustrate alternative materials employed for a wipe 20 but the combination and system remain consistent.

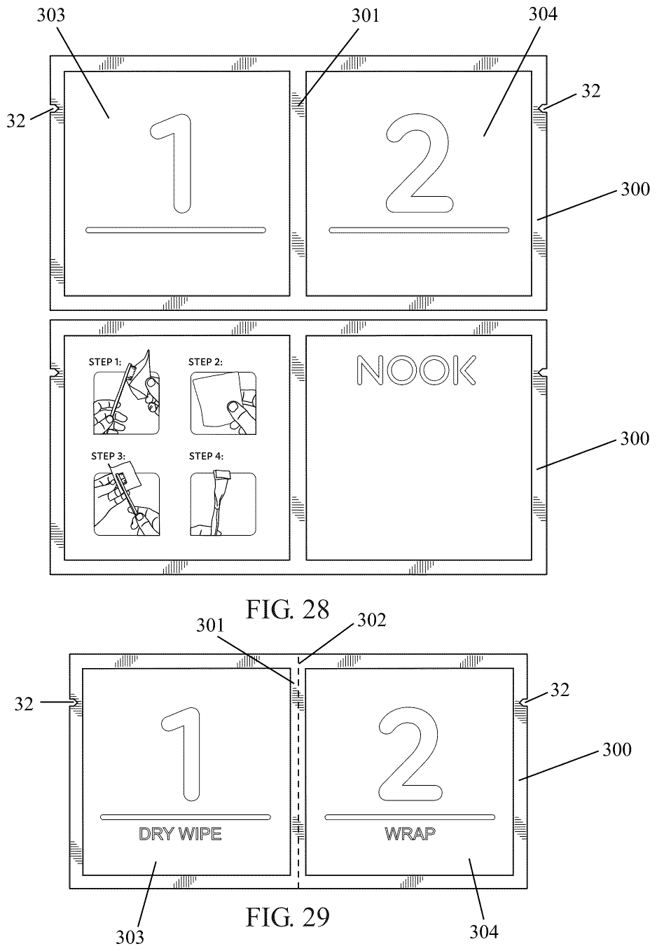

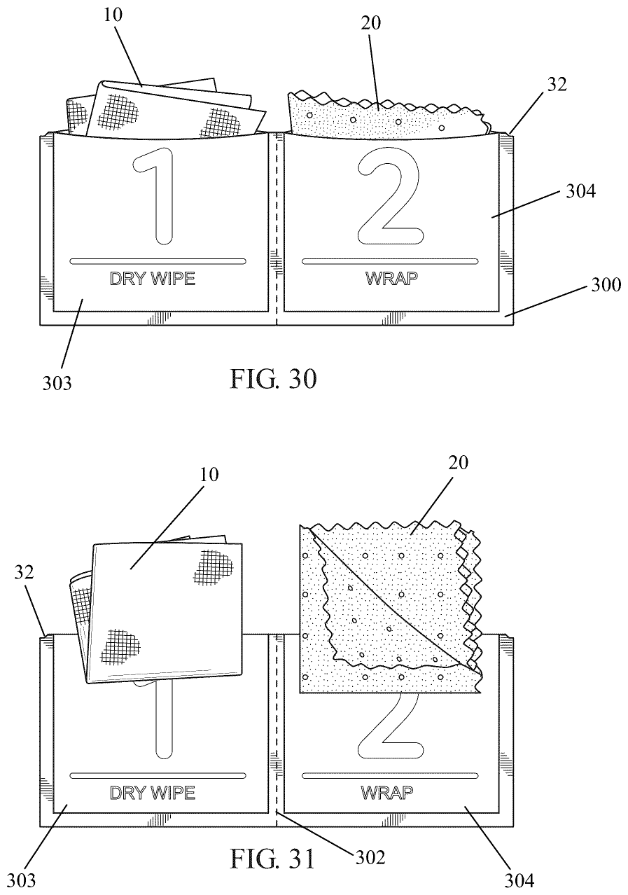

Alternative sealed packet configurations also contemplate an interior seal 301 to create a dual-compartment container to enclose the wipe in a first section chamber 303 and enclose the wrap in a second section chamber 304 of the same sealed packet 30. Examples of the divided packet are represented in FIGS. 26-31. The divider seal 301 is present in each of these views in addition to the external seal 300 around the four edges of the packet. For this compact, separated embodiment, each sheet is folded-over a series of times. In the preferred embodiments, the packets are each square, sealed containers. When either the wipe or wrap are removed for use, they are easily unfolded and expanded for ideal wiping and wrapping sizing. The wrap may be folded back onto itself several times, and because it has self-grabbing attributes, adding a dog eared finger-grab on the final fold will permit easier unfolding (see FIG. 31). Optionally, the divider seal 301 could include a perforated tear line 302 for easy separation of the first section 303 and the second section 304 (See FIGS. 26 and 29-31). This divided packet system can utilize the many opening options including tear strips 33 (see FIG. 26), corner peels 31 (see FIG. 27), and tear notches 32 (see FIGS. 28-29). This divided packet variation also contemplates keeping the size of the packaging compact so the wipe and the wrap would be folded as shown in FIGS. 30-31.

Turning to FIGS. 32-43, other embodiments of the present invention are depicted. These variations show a system with a plurality of wipes 10 and wraps 20 provided in a container which allows for single dispensing of one apart from the other and does not require a single pair to be sealed together. Some variations of this aspect of the present invention, provide the system 1 in a double compartment dispenser 50. Desirably, each compartment includes a narrow slit or slot through which to dispense the respective wipe or wrap material. In one aspect of this dual dispenser variation, the respective materials are folded together in an interlocking stack so when one wipe is pulled out it prepares the next wipe by dragging along the next end to be exposed through the slit. Or, for the wrap, when a wrap is pulled free for use, the next wrap also is pulled forward so that the end of the folded wrap is ready for the next use. In some instances, a buffer sheet 202 may be needed between each wrap.

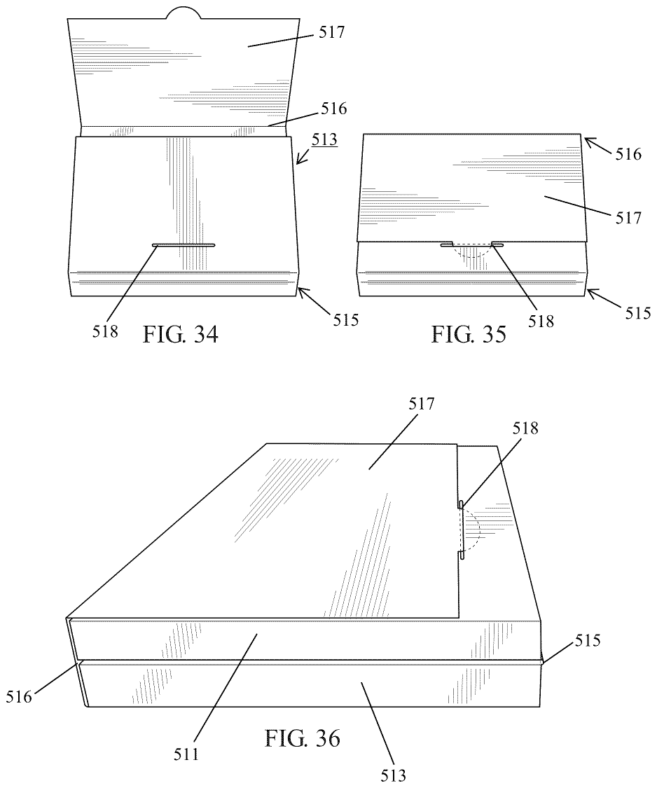

With particular reference to FIGS. 32-36, in the first embodiment of this variation, the double compartment dispenser 50 is a foldable dual compartment container 51 used for dispensing a drying wipe and wrap system 1. In this embodiment, a towel or wipe 10 is held in a wipe compartment 511 and dispensed from the first slot 512. A wrap compartment 513 is provided to dispense the wrap 20 from the second slot 514. The slots can be reversed but desirably occur on either side of a first fold 515. When the container is to be closed, the user bends the external body at the first fold 515 so that the slots 512, 514 are touching (see FIG. 34). Then, the second fold 516 is bent so that the cover 517 abuts the back of one of the compartments (see FIGS. 35-36). This variation could be modified such that the back of one of the compartments abuts the opening of the other compartment and the cover 517 abuts the remaining compartment opening.

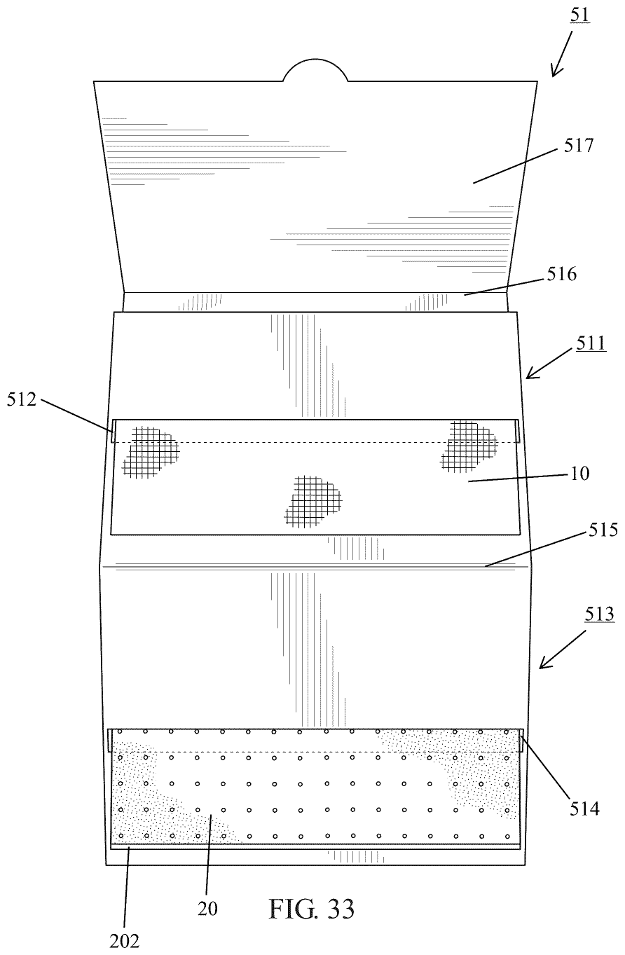

FIGS. 34-36 schematically represent the flap lock 518 used to secure the closure of the package version shown in FIGS. 32-33 when the foldable dual compartment container 51 is in the closed position. The following example sizing is provided by way of example and not by way of limitation: when closed, this example of a package is compact with dimensions of approximately 3 ¾ inches wide, 2 ¼ inches long, and ⅜ of an inch thick but alternative sizing is also contemplated depending on the size and quantity of sheets used (see FIG. 35-36). The foldable, dual compartment container 51 is illustrated in a partially open position in FIG. 34. FIG. 33 is a top view of the same package in a fully open position. When this example package is fully opened as shown in FIGS. 32-33, each compartment is approximately sized at 3 ¾ inches by 2 ¼ inches and the thickness is approximately 3/16 of an inch or half of the total thickness which in this instance is approximately ⅜ of an inch. In this example package, the entire length of all the compartments and closure flap, including the flap lock 518, when open, together is approximately 6 ½ inches. Again, alternative sizes are anticipated depending on the size and quantity of sheets.

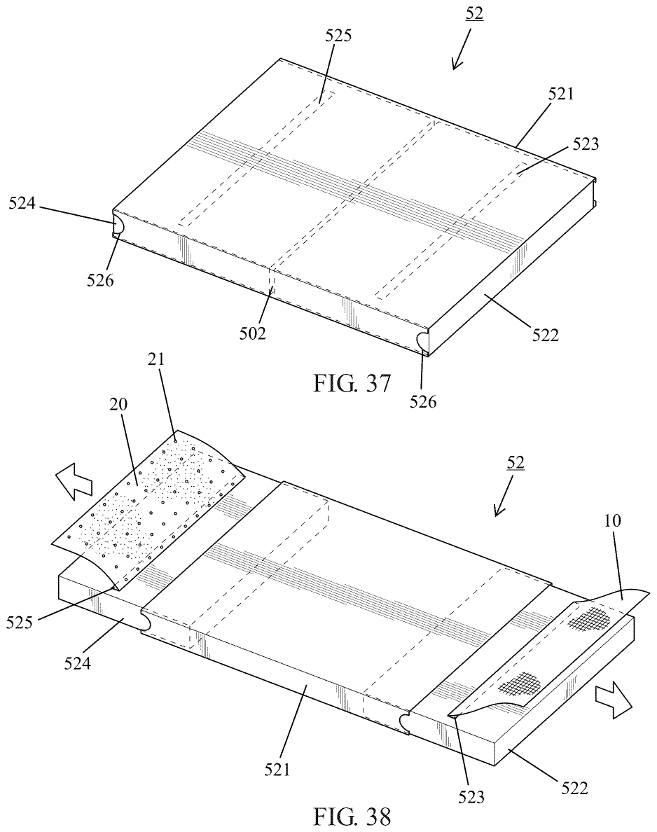

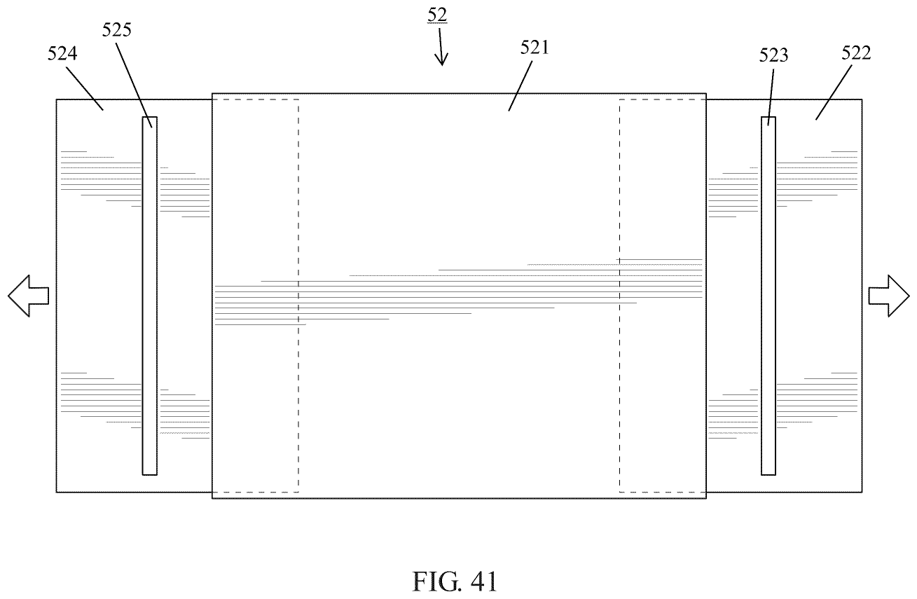

Next, in FIGS. 37-41, a second example of a double compartment dispenser 50 is illustrated. In particular, a double, or dual slide out compartment 52 is provided. In FIG. 37, a dual compartment slide out container 52 used for dispensing a drying wipe and wrap system 1 is shown in the closed position. In this aspect, the dispenser box has two compartments each having six sides to form a box that allow separate storage of the wrap and wipe sheet materials and the compartments can be pulled out from opposing sides of the sheath 521. As illustrated by arrows in FIGS. 38 and 41, the respective compartments are held within the sheath (FIGS. 37, 39, and 40) and slide in opposing directions along the same axis to expose the respective slots on one side of each compartment 522, 524 such that the wipe and wrap materials are accessible. In this example, one compartment houses wipes 10 and a second compartment houses wraps 20. It may be desirable to provide a disposable divider 202 between each wrap provided in the container (see, e.g., FIG. 33), whether they are stacked, folded, or rolled. In a preferred embodiment, beeswax sheets are employed as the wrap 20 material and will benefit from such separation by buffer sheets 202 during storage with other beeswax sheets. An external sheath 521 protects the compartments which abut each other on their respective interior panels near the center of the sheath 502 while the top panels house access slots (523, 525) to the dispensing compartments. Thus, a wipe compartment 522 includes a wipe dispensing slot 523. Then, a wrap compartment 524 is accessed through the wrap dispensing slot 525.

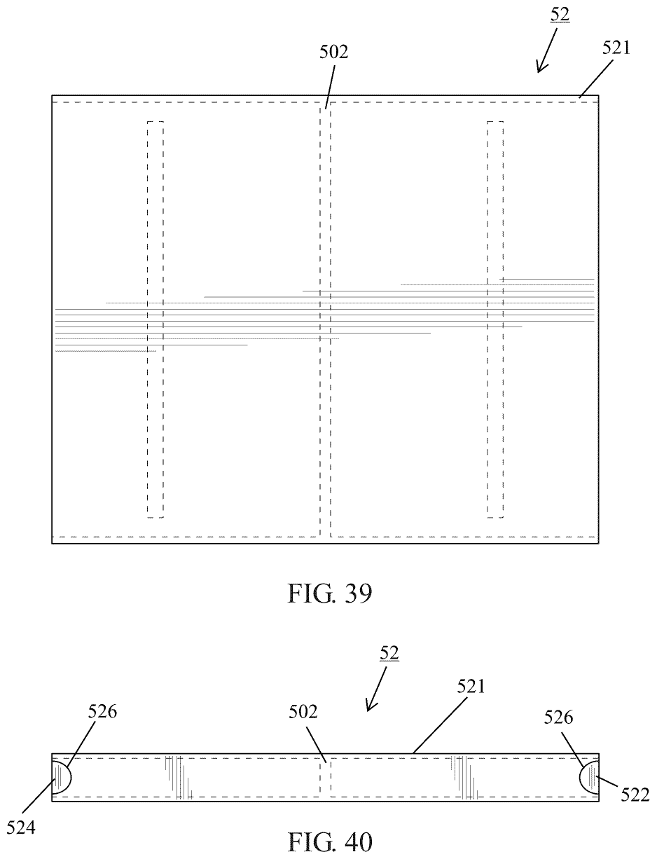

In FIG. 38, airholes 21 in the preferred wrap material 20 are visible. The airholes 21 allow for air to circulate when the wrap 20 is around the brush head enhancing drying of the bristles between uses and discouraging bacterial growth. FIG. 39 is a top view of the package shown in FIGS. 37-38 having the slidable dual compartments in the closed position. The bottom view would look the same, but the respective slots would not be demonstrated since each compartment is fully enclosed with six side panels. FIG. 40 is a view from either side of the container in FIGS. 37-41. A user would grab the respective compartments at the sheath cutouts 526 and slide the respective compartment out of the respective end of the sheath. Then, FIG. 41 is another top view but this time shows the inner sleeves pulling away from the central sheath 521. The samples illustrated represent some relative sizing recommendations for the slidable dual compartment container. These sample dimensions are provided by way of example and should not be construed as limitations. The overall width may be approximately 4 and 9/16 inches with each internal compartment taking about half the container at approximately 2 ¼ inches each. The length of the container may be approximately 3 ¾ inches and the internal compartments would be slightly smaller. Finally, the thickness of the container as shown in this particular sample may be approximately ⅜ of an inch but could be thicker depending on the number of sheet materials being stored. The views in FIGS. 39-41 do not illustrate the sheet materials contained in the compartments 522, 524 labeled as pockets 523, 525 in these illustrations. This embodiment could be modified to offer a single compartment with only a single slot such that the combination wipe and wrap pairing would also be stacked in an alternating fashion for dispensing, one at a time, but from the single slot. In this aspect, a buffer sheet 202 should not be required as the wipe 10 will offer separation of the wraps 20. When a first wipe is dispensed it would expose a first wrap followed by a second wipe and a second wrap, and continuing, through the entire contents of the container.

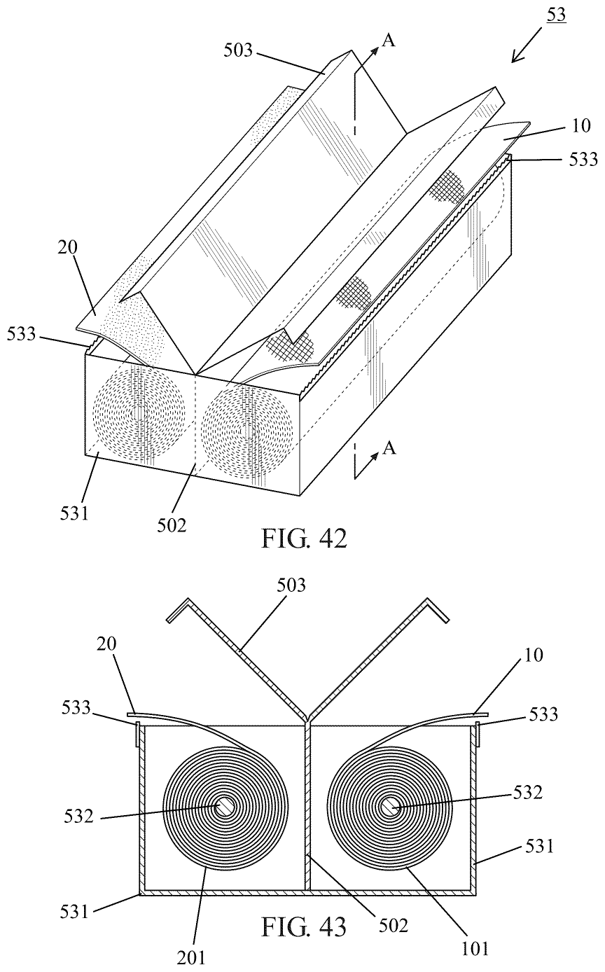

Yet another example of a double compartment dispenser 50, particularly a dual roll container 53 is illustrated in FIGS. 42-43. This example may not be to scale but offers an external box 531, such as made from cardboard. The box 531 includes a minimum of 5 panels to form four side walls and a floor, but may include an interior divider 502 and lid 503. The box 531 encloses respective rolls of the wipe 10 and wrap 20 sheet materials. Desirably, FIG. 43 illustrates the respective rolls, one roll of wipes 101 and one roll of wraps 201, which are situated next to one another and may be separated by an internal separating panel 502. In the illustrated example, the rolls of wraps 201 and the roll of wipes 101 each have a central rotation apparatus 532. If needed, a sharp, cutting edge 533 may be provided at the opening of respective dispensing slots to aid in the cutting or tearing needed to separate a sheet of material at a desired length. The roll 201 of wrapping material 20 may include a divider sheet 202 similar to the divider sheet shown in FIG. 33 to ease separation when being unrolled. For ease of use, large, contiguous stretches of material are scored with a separation line, such as by perforation in between the respective sheets (not shown). Using the line as a guide or aid, a user may tear, pull, or cut away one sheet from the length of the stored material.

Having a dual compartment for individually provided sheets of wrap or wipe has added advantages. One of those advantages permits ala carte usage of one material or the other. Users may desire to use a clean wipe each time they remove debris and moisture from their brush but they may choose to reuse the wrap a number of times before retrieving a replacement from the dispensing compartment. Another benefit of separate dispensing compartments permits the optimization of the dispensing features for the respective materials. When compressible, self-grabbing material is used for the wrap, it may have a tendency to stick to itself inside the storage container. Thus, it may be desirable to provide a disposable contact or backing sheet in between the layers of the wrap material provided in the container, whether they are stacked, nested, folded, or rolled. The beeswax sheets which may be employed as the wrap will benefit from such separation during storage.

Importantly, the system will provide reliable sheet storage in a protective layer. The smaller container options for the system 1 will have advantages for portability and can be easily kept in a clothes pocket or toiletry bag. The larger options may use a box or cardboard exterior. These versions will find particular utility in larger bathroom settings. For some options offered to customers, the packaging may call for sanitization or irradiation to ensure hygienic condition of the system components prior to use. The storage for the sheets may be contiguous or opposing. Spooled rolls may be adapted for desirable storage of the sheets. A cutting bar 533 or interrupter may aid in tearing away sections provided for end-to-end sheet configurations whether flat or rolled. Some containers will also desirably comprise opposing stacked storage where wiping towels are stored on the opposite side of a box container from the wrap. The containers employed for stacked storage may have facing access points within a foldable boxed container. Finally, containers will desirably be made of recycled materials.

FIGS. 1-9 and 23-25 demonstrate the method of using the present system to wipe and wrap the bristles of a toothbrush head. The method taught by these images would similarly apply to a wipe and a wrap which have been retrieved from any of the packaging suggested in this disclosure. For iterations which have separate storage for the wipe and wrap, the step of retrieving the wrap is desirably delayed until the user has completed the wiping task. As one example, the method will be described in the context of the dual compartment, slide out container 52 as follows:
retrieve the container 52 (see FIG. 37);
access the wipe compartment 522 by sliding the sheath 521 away from the wipe dispensing slot 523 (FIG. 38 or 41);
pull a wipe 10 from the wipe compartment 522 (FIG. 38) and expose the next wipe to be used next time (not shown);
wipe and dry the bristles (see FIGS. 2-4; also see FIG. 23);
dispose of the wipe (not shown);
access the wrap compartment 524 by sliding the sheath 521 away from the wrap dispensing slot 525 (see FIG. 38);
pull a wrap 20 from the wrap compartment slot 525 (see FIG. 38) exposing the next wrap to be used next time (not shown), and if a compressible, self-grabbing material is used for the wrap, dispose of any buffer sheet;
wrap the bristle head 62 with the wrap 20 and secure the wrap 20 to itself by squeezing the base of the wrap 20 around the brush handle 63 (see FIGS. 5-9 and also FIGS. 24-25); and
store or transport the toothbrush until the next use.

Methods for using the system 1 will provide a solution to dry, clean, and store a toothbrush. After removing a towel from a container, the bristles are wiped and cleaned, and then a protective cover is applied over the cleaning end of the toothbrush. Using a single wipe the user can dry bristles and remove debris from the toothbrush after use. Then, the user covers the bristles with the aid of unique features of the wrap that include breathability and self-adhering capability. The toothbrush is then hygienically and safely stored with the wrap until the next use. A user may choose to place the wrapped brush in another cover or case but it is not required. Then, for the next instance of using the toothbrush, the wrap is removed and may be discarded or reemployed depending on the user's preferences. The system allows for convenience and portability so the user may easily repeat use, even if they need to carry a new wipe and new wrap for the next use. The system applies equally well to all sizes and styles of toothbrushes whether they be manual, mechanical, or electric.

Throughout this disclosure, the noun “wipe” has been used to refer to the absorbent sheet portion of this system. The wipe is desirably a disposable towel or other absorbent dry cloth that will aid in drying and removing debris from toothbrush bristles. The material should be thin for ease of stacking, folding, rolling, storage, and portability. The material employed will be inexpensive in order to encourage one-time use. The wipe sizing may be any size that will serve the objectives of the present invention. Any shape may be used for the wipe but particular examples include squares, rectangles, circles, and triangles. One particular possibility for sizing and shape features will call for approximately 3-inch by 6-inch sheet folded in the middle to effectuate an approximately 3 inch by 3 inch square. Other shapes and sizes are contemplated. Additional folding is contemplated to meet smaller packaging objectives as shown, for example, in FIGS. 30-31. Alternative sizing will be useful and desirable to meet the objectives of the invention. The material provided will ideally be organic cotton or absorbent paper. Synthetic or microfiber materials will have particular utility for the drying function and objectives described herein.

The wrapping material used will meet the objectives of the present invention. In the present invention, a single sheet wraps around bristles and sticks to itself. The material may fold closely around, or stick, to the handle. The preferred material needs to be deformable (able to be altered) in order to be conformable (to fit the 3D shape of the bristles while reliably holding to the brush handle). It is compressible to form closely around the toothbrush bristles without crushing them and the toothbrush head at the base of the bristles, two very different circumferences. The material is also a self-grabbing material or fabric that sticks back to itself without need of an external adhesive to keep the material around the toothbrush head until removed by the user. The concept is similar to a lollipop cover but the material is coated with a wax or sticky material that removably, and perhaps repeatedly, clings to itself. The wrap is also food grade material safe for human consumption or is otherwise inert and will not cause harm to humans. This is a necessary feature given that it is contacting a toothbrush which is used in a human's mouth. In one embodiment, beeswax paper such as the brand Bee's Wrap is made of GOTS-certified organic cotton. This material can be made from responsibly sourced beeswax and has organic plant oil and tree resin. This combination of such ingredients creates the desired effects of being a deformable, conformable, shapeable, pliable, malleable, moldable, material that can be bent, influenced, pinched, folded, twisted, and manipulated to create a custom-sized wrap that adheres back upon itself repeatedly. When compressible, self-grabbing material is used for the wrap, it may have a tendency to stick to itself inside the storage container and may need a buffer sheet. Desirably, the material employed for the wrap is perforated or has other characteristics that make it breathable, allowing air to flow over the bristles and aid in final drying in between uses but preventing contaminants from contacting the brush head. The wrap sizing may be any size that will serve the objectives of the present invention. Any shape may be used for the wrap but particular examples include squares, rectangles, circles, and triangles. One particular possibility for sizing and shape features will call for approximately 3.5 inches by 3.5 inches, essentially a square but a rectangular shape or other shapes and other sizes may be desirable to maximize cover while minimizing cost. The beeswax paper used in one embodiment can be reusable as it is able to grab onto itself due to the sticky properties of the wax, but can be removed and then applied around the brush head multiple times, so long as the toothbrush will not be contaminated by such reuse. Examples of other materials with characteristics that may suit the objectives of the invention include parafilm tape or specialized plastic or wax wraps. As one alternative, a canvas style fabric could be employed and even joined with a drawstring to aid in the closure of the bristle head within the wrap.

The Applicant asserts claims to a packaged, combination toothbrush wipe and pliable toothbrush wrap, comprising: a plurality of absorbent sheets, a plurality of pliable sheets having perforations and contiguous self-grabbing properties, a dispenser, wherein the dispenser holds the plurality of absorbent sheets and the plurality of pliable sheets.

According to one iteration: (1) the plurality of disposable absorbent sheets are joined contiguously, separable, and spooled around a first roll; (2) According to this iteration, the plurality of pliable sheets are joined contiguously, separable, and spooled around a second roll; (3) The dispenser holds the first roll and the second roll.

In another variation, the plurality of pliable sheets are folded such that removal of one pliable sheet from the dispenser advances and exposes an end of a next pliable sheet for further dispensing.

The plurality of disposable absorbent sheets are folded such that removal of one absorbent sheet from the dispenser advances and exposes an end of a next absorbent sheet for further dispensing.

The Applicant asserts claims to a method for hygienically drying and storing a toothbrush according to the present disclosure. One particular example of the method comprises the steps of: using the toothbrush in a conventional manner causing a bristle head to become wet, retrieving a disposable absorbent wipe from a first dispenser through a first dispenser opening, drying the bristle head with the absorbent wipe, disposing of the absorbent wipe, retrieving a reusable, pliable sheet from a second dispenser through a second dispenser opening, wrapping the bristle head in the reusable, pliable sheet such that the deformable sheet molds around the bristle head and adheres to itself, whereby the bristle head is protected for transport or storage until the next use.

The Applicant asserts claims to a system for hygienically drying and storing a toothbrush according to the present disclosure. More particularly, the system comprises: a single box, a plurality of sealed packets contained in the single box, each of the plurality of sealed packets further comprising a disposable absorbent sheet and a pliable sheet having contiguous self-adhesive and breathable properties, wherein each of the plurality of sealed packets is dispensed from the single box and unsealed to first access the disposable absorbent sheet useful in removing moisture from a toothbrush bristle head, whereupon the pliable sheet is also accessed and wrapped to mold around the toothbrush to substantially cover the toothbrush bristle head until the toothbrush is again deployed for use.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” and the like in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

As used in this disclosure, the term “dry wipe” or “wipe” may be further understood to comprise and incorporate the terms: drying wipe, dry cloth, towel, wiping towel, clean wipe or any combination or variation of these terms. The wipe desirably includes characteristics of being a sheet material that is absorbent and disposable and thus, those descriptors may also be used. As referenced in this disclosure, the term “wrap” may be further understood to comprise and incorporate the terms: protective wrap, pliable sheet, deformable sheet, malleable toothbrush wrap, cover or any combination or variation of these terms. The wrap desirably includes characteristics of being a sheet material that is protective, non-absorbent, pliable, disposable, reusable with limited reuses, deformable, malleable, and thus, those descriptors may also be used. The portion of the invention termed the packet may be further understood to comprise and incorporate the terms: package, pocket, chamber, or wrapper. The packet may desirably be gathered together in a multi-packet container. This multi-packet container may be further understood to comprise and incorporate the terms: carton, boxed set, hanging box, and folding envelope. The packaging combination of wipe and wraps in repetitive pairings may be referred to herein as a dispenser. The dispenser may be further understood to comprise and incorporate one or more of the following terms: compartments, trays, sheaths, sleeves, sliders, rolls, spools, pop-ups, or foldable or other boxes. The dispenser may have one or more openings. The openings may be further understood to comprise and incorporate the terms: slits, slots, ports, cutting edge, or lids. Then, any of the various dispensers may have a single aspect or a multiple aspect for dispensation. The repetitive pairings of the wipe and wrap may alternate from a single location or may have separate but corresponding dispensers-one for repeating wipes and one for repeating wraps. For combinations that call for repeating wraps to be housed together in a dispenser, it may be necessary to include a buffer sheet. Buffer sheet may be further understood to comprise and incorporate the terms: divider, backing or contact sheet, any of which may be considered disposable. Regardless of the structure collecting the combinations of wipes and wraps, an easy-opening access is provided. The access aid to open the various containers may optionally be referred to as seal breaching access, seal-breaching feature, opening access, or access aid, such as those suggested by the corner peel, tear notch, dog ear, tear strip or opening strip.

The wipe and wrap combination may be housed in any packaging configuration, comprising: a one-for-one combination, separately folded and sharing one packet, jointly folded and sharing one packet; a one-for-one combination laying flat such as in a stack and sharing one packet; or a one for one separated combination sharing a joined packet. The various packages of wipe and wrap combination may then be provided in multiples and in various configurations, comprising: a one-for-one combination, folded and sharing one packet; a one for one combination laying flat and sharing one packet; or a one for one separately enclosed combination such as in separate chambers sharing a joined pockets. Each of the one-for-one combinations will then be joined in multiples such as in cartons, retaining their discrete combinations for individual resale, volume discounts, or end-user portability. Alternatively, a plurality of wipe and wrap combinations may be provided in volume, but separately, such that dispensers are required to obtain a wipe and a wrap material prior to use. The dispensers may be chosen from various options, comprising, a foldable dispenser, a slide out dispenser, or a roller dispenser. In various aspects of the invention, the respective sheets may be folded, layered, or rolled. In any variation, the various sheet materials may be tethered end-to-end in any manner known in the art. In aspects of the invention employing dispensers, the dispensers may have segregated-compartments or a joined-compartment. Variations using joined compartments may alternate one wipe for every one wrap thereby providing one-for-one combinations en masse.

It is further intended that any other embodiments of the present invention which result from any changes in application or method of use or operation, method of manufacture, shape, size, or material which are not specified within the detailed written description or illustrations contained herein yet are considered apparent or obvious to one skilled in the art are within the scope of the present invention.

What is claimed:

1. A packaged, combination toothbrush wipe and malleable toothbrush wrap, comprising:
an absorbent sheet,
the absorbent sheet being constructed of a single, contiguous material,
a non-absorbent, pliable sheet,
the non-absorbent, pliable sheet being constructed of a single, contiguous material, such material having self-adhering and moldable properties,
wherein the absorbent sheet and the non-absorbent, pliable sheet are jointly packaged.

2. The packaged, combination of claim 1, wherein the absorbent sheet and non-absorbent, pliable sheet are joined in a single, sealed packet.

3. The packaged, combination of claim 2, wherein the single, sealed packet comprises a first section and a second section separated by an interior seal 4. The packaged, combination of claim 2, wherein the single, sealed packet further comprises a seal breaching access.

5. The packaged, combination of claim 2, wherein the single, sealed packet is grouped with a plurality of other single, sealed packets and boxed together in a single carton.

6. The packaged, combination of claim 1, wherein the non-absorbent, pliable sheet allows air flow.

7. A combination toothbrush wipe and pliable toothbrush wrap, comprising:
a plurality of absorbent sheets,
a plurality of non-absorbent sheets having contiguous self-grabbing and breathable properties,
wherein each of the plurality of absorbent sheets and each of the plurality of non-absorbent sheets are individually housed in a single container.

8. The combination of claim 7, wherein each of the plurality of absorbent sheets are stored in a first section of the single container.

9. The combination of claim 8, wherein each of the plurality of non-absorbent sheets are stored in a second section of the single container.

10. The combination of claim 7, wherein the single container further comprises a dispenser.

11. The combination of claim 10, wherein the dispenser further comprises dual, slide-out sleeves.

12. The combination of claim 10, wherein the dispenser further comprises a sheath.

13. The combination of claim 10, wherein the dispenser further comprises dual, foldable pockets.

14. The combination of claim 10, wherein a first compartment and a second compartment are disposed on either end of a double compartment housing.

15. The combination of claim 14, wherein the absorbent sheets and non-absorbent sheets are stored in opposite sides of the first compartment and the second compartment.

16. The combination of claim 14, wherein the plurality of non-absorbent sheets are stored in either the first compartment or the second compartment.

17. The combination of claim 16, wherein the plurality of non-absorbent sheets are separated by a buffer sheet for easy dispensing.

18. The combination of claim 7, wherein the plurality of absorbent sheets are separably connected, end to end.

19. The combination of claim 7, wherein the plurality of non-absorbent sheets are separably connected, end to end.

20. A packaged, combination toothbrush wipe and protective cover, comprising:
a drying wipe,
the drying wipe constructed of a disposable absorbent sheet material,
a pliable wrap sized to fit around the head of a toothbrush,
the pliable wrap being constructed of a non-absorbent and air-permeable material, such material having self-adhering and deformable properties,
a dual-compartment container having a first chamber separated from a second chamber,
the dual-compartment container further having at least one seal-breaching feature,
wherein the drying wipe and the pliable wrap are respectively sealed in either the first chamber or the second chamber and are accessed through the at least one seal-breaching feature.
